(19) United States
(12) Patent Application Publication
(10) Pub. No.: US 2014/0315179 A1
(43) Pub. Date: Oct. 23, 2014

(54) Educational Content and/or Dictionary Entry with Complementary Related Trivia

(71) Applicant: Lee Michael DeGross, Fort Lee, NJ (US)

(72) Inventor: Lee Michael DeGross, Fort Lee, NJ (US)

(21) Appl. No.: 13/867,039

(22) Filed: Apr. 20, 2013

(51) Int. Cl. G09B 7/06

(52) U.S. Cl. CPC G09B 7/06
USPC 434/362

(57) ABSTRACT

A fast convenient process for understanding a word or phrase displayed on a computer screen. A user selects the word and instantly triggers the display of an educational content such as a definition for the word. A complementary related trivia meant to be fun also is displayed. A pop-up space can be utilized to present the educational content and the trivia. The educational content can be dictionary entries such as parts of speech, senses, and etymologies. The educational content can be other reference materials, or literary criticisms, or historical information. The educational content can be images or moving images that convey, for example, a meaning for the selected word. The complementary trivia can be related, for example, to the selected word or to the educational content. The trivia can be presented in multiple formats. The process helps a person learn about words, and the fun trivia enlivens the educational experience.

### CROSS-REFERENCE TO RELATED APPLICATIONS

This application claims the benefit of provisional patent application Ser. No. 61/635,871, filed 2012 Apr. 20 by the present inventor.

### FEDERALLY SPONSORED RESEARCH

Not applicable

### SEQUENCE LISTING OR PROGRAM

Not applicable

### BACKGROUND

1. Field

This application relates to the field of computers, specifically to educational digital multimedia processes.

2. Description of Prior Art

The less relevant prior art will be discussed first and will progress to the more significant prior art. For purposes of brevity, the words “select”, “selection”, “selecting”, “selects”, and “selected” encompasses all of the various selection methods of a computer.

The first prior art is the thesaurus function of Microsoft Word™, a popular word processor program. The fastest sequence requires a right-click on a word, which yields a pop-up menu having a “Synonyms” choice, and after the choice is selected a synonyms list is shown.

A disadvantage of the thesaurus function is its slowness and unwieldiness. At least two selections are needed to get the synonyms for a word. The pop-up menu is unwieldy because it has 11 other choices and most are word processing functions.

The next prior art is the dictionary function of Microsoft Word™. The fastest sequence requires the right-click on a word, which yields a pop-up menu having a “Look Up . . . ” choice, and after the choice is selected a tall research column appears top to bottom on the right outside of the word processor page, layout, or window. The column shows the dictionary information for the selected word, an input box for entering words, a drop-down menu of various dictionary and thesaurus titles, a translation feature, and various research, business, and financial website links for selection.

A disadvantage of the dictionary function is its slowness and unwieldiness. At least two selections are needed to get the dictionary information for a word. The pop-up menu is unwieldy because it has 11 other choices and most are word processing functions. Another disadvantage is the absence of a pop-up space with dictionary information near the selected word.

Another disadvantage is the absence of a pop-up space with the dictionary information near the selected word. The user is forced to divert his or her attention from the literature and look to the right edge of the computer screen. Another disadvantage is that the research column takes up valuable screen space, almost a quarter of it.

Another disadvantage is that the research column does not immediately provide images such as drawings, photographs, comics, animation, videos, cartoons, movies, computer generated imagery, and 3-dimensional imagery for the selected word.

The next prior art are “The Oxford Pop-up English Language Reference Shelf©”, “The Oxford Pop-up French German Spanish Dictionary Shelf©”, “The Pop-up Concise Oxford English-Duden German Dictionary©”, and “The Pop-up Oxford English-Duden German Dictionary©”. These prior art are made by the same companies.

The 4 prior art, via a CD-ROM, provide a pop-up window with a search field for entering words to get its menus and dictionary and reference information in the same pop-up window. Alternatively the user can double-click on a word in any Microsoft™ Windows™-based application, or place a cursor over a word on a web-page in Microsoft's™ Internet Explorer™. A pop-up appears with menus and the dictionary and reference information.

The multi-language dictionary CD-ROM's provide translations of a word. The “Oxford Pop-up English Language Reference Shelf©” has a thesaurus, a dictionary of quotations, and a world encyclopedia that the other CD-ROMs do not have.

A disadvantage of the 4 CD-ROMs is that their features of double-clicking or placing a cursor over a word to get the pop-ups are limited to the specific Microsoft™ products. Another disadvantage is that the 4 CD-ROMs do not provide some essential dictionary meanings. Two examples are syllable breaks and pronunciations. Another disadvantage is that sound is not utilized such as to give a pronunciation sound of a word.

Another disadvantage is that the 4 CD-ROMs do not provide imagery such as photographs, comics, films, movies, animations, videos, cartoons, claymation, stop-action imagery, 3 dimensional imagery, and computer generated imagery for a word.

The next prior art is U.S. patent application Ser. No. 11/469,078 entitled “Reading Comprehension System and Associated Methods”. The application describes a computer teaching system utilizing, for example, a story. The system implements a story database, an illustration database, a vocabulary database, and a questions database to provide reading comprehension instruction about a portion of the story for students. The student may be prompted to answer questions at predetermined points in the story. The questions can be about details of a portion of the story, and to enhance the student's ability to remember the details. The questions can be about the student's reading comprehension of the overall story.

A disadvantage of the application is that it teaches about a portion of the story, and not about a specific word or phrase in the story. Another disadvantage is that vocabulary words and their definitions relating to a portion of the story may be or is automatically displayed at a later step.

Another disadvantage is that the application does not describe other dictionary entries like pronunciations, parts of speech, senses, synonyms, antonyms, or etymologies. It does not describe other reference materials such as those of thesauruses, almanacs, encyclopedias, or summaries.

Another disadvantage is that the questions about story details and for story reading comprehension, while important to its teaching system, are boring.

Another disadvantage is that a student is allowed to advance to a more difficult story after achieving a predetermined level of reading comprehension skill based on the answers to the questions about the less difficult story. This is constraining because a student using the system has no freedom to read any story.

The next prior art is U.S. patent application Ser. No. 12/449,406 entitled “Computer-implemented learning method and apparatus”. The application describes a computer adaptive language learning method for a learner who is, for example, reading a book. The relevant features are that the learner selects a word and learning objects are displayed such as a pronunciation, a definition, or a synonym. A multiple choice question can be displayed that is called a vocabulary learning object in the preferred embodiment. Tests and quizzes are also described. The multiple choice questions teach the system's form, meaning, or usage aspects of knowledge about the selected word. A library is described that can be queried to retrieve a suitable learning object. The application describes a traditional dictionary in the “BACKGROUND ART” section.

A disadvantage, although the application describes that its learning objects are only examples, is that it does not describe other dictionary entries like senses, parts of speech, antonyms, or etymologies. It does not describe other reference materials such as those of thesauruses, almanacs, encyclopedias, or summaries.

Another disadvantage is that the multiple choice questions or quizzes or tests, while important to its vocabulary learning methods, are boring.

The application describes so many complex features, functions, results, and aspects that need to work in its stated “fluent” and “effective” way. This complexity is a disadvantage when compared to significantly simpler processes that presents the most of the same educational content for a word. An example is the 4 “Oxford” CD-ROMs described above. This complexity is also a potential disadvantage because it may be too burdensome to be “fluent” or “effective”.

The application and its major complex features, functions, results, and aspects will be discussed next. The application describes adaptive learning methods that change the displayed learning objects for the same selected word depending on the learner's progress. It describes handling a learner having a conversation in the same way the learner is reading. It describes a learner-tracking component which tracks a learner's performance in the learning activities. It describes a personalized management that advances the learner's knowledge. It describes a tracking history component that is updated as the learner uses the system, and is accessed and updated by various external systems. It describes activities such as giving a hint, learning exercises or games, and tutorials. It describes an automated or manual decision-making processes that includes, for example, an expert system with a procedural inference engine and a separate rule base incorporating an instructional model about a target subject. It describes an eye-gaze tracking system for determining which words in the text have been viewed, how often, or at what speed to inform the decision-making process. It describes the system preferably running separately while the learner is reading. It describes a predetermined scheme devised to manage an overall learning process for the learner, and user information such as the learning level of the learner and a list of vocabulary items to focus on. It describes a learning management module that deactivates itself into a waiting state for another activation. It describes the level, stage, difficulty, or importance of learning the words. It describes an inference engine to select which type of learning object and to determine the specific learning object to return. It describes ensuring that a range of particular learning objects are presented to the learner over time, and that learning objects are not repeated unless necessary. It describes recognizing the learner acquiring sufficient knowledge of higher frequency words then he or she can proceed to words of lower frequency. It describes probability values that measures the success in having learned an aspect of knowledge, depending on a range of types of factors such as time span and learning objects encountered. It describes determining if the learner is experiencing difficulty in learning the word using threshold parameters such as 30% success, and if remedial action is called for. It describes apparatuses that provide the described methods and systems, and the combinations of the methods, systems, and apparatuses.

A disadvantage of the above prior art references is that they do not provide any fun trivia to enliven the learning experience.

The next prior art is called “SuperMunchers Trivia” which is available on a CD-ROM. This computer trivia game combines arcade action and trivia questions. Players must control their Munchers and munch the answer to questions while evading Troggles, who can eat the Munchers. A player's trivia knowledge is tested by munching as many answers as it can. The disadvantage is that the trivia game does not have any educational content such as dictionary entries.

The next prior art are the patents and patent applications in the Information Disclosure Statement about different computer trivia versions. The disadvantage of these trivia versions is that none describe or teach presenting any dictionary entries for a word.

This concludes the prior art section.

### SUMMARY

A fast, convenient process for enabling a person to see an educational content for a word or phrase displayed on a computer screen. When the person selects the word, a pop-up space instantly appears nearby presenting the educational contents. Also presented is a stimulating complementary related trivia. The educational contents can be dictionary entries such as pronunciations, parts of speech, definitions, senses, and quotations. More examples of the educational contents are other reference materials, meanings, commentaries, criticisms, interpretations, and narratives for the selected word. The educational contents can be images and moving images that convey a meaning for the selected word. The complementary trivia can be related, for example, to the selected word or the pop-up space educational contents, and are presented in many possible formats. The pop-up space educational contents and complementary related trivia can be calibrated for audiences of different ages, or customized for different occupations. The results provide educational, learning, informative, and fun benefits.

### DRAWINGS

### Figures

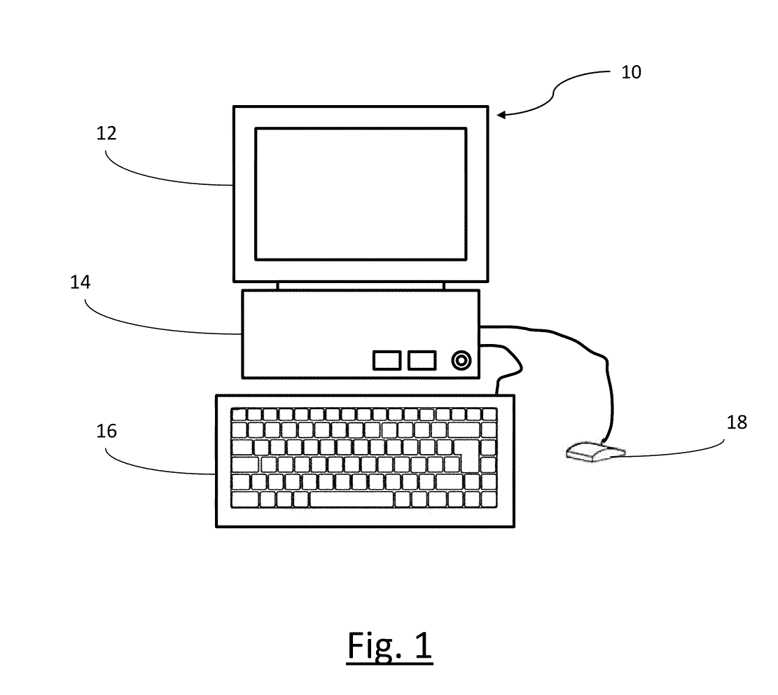

FIG. 1 shows a computer.

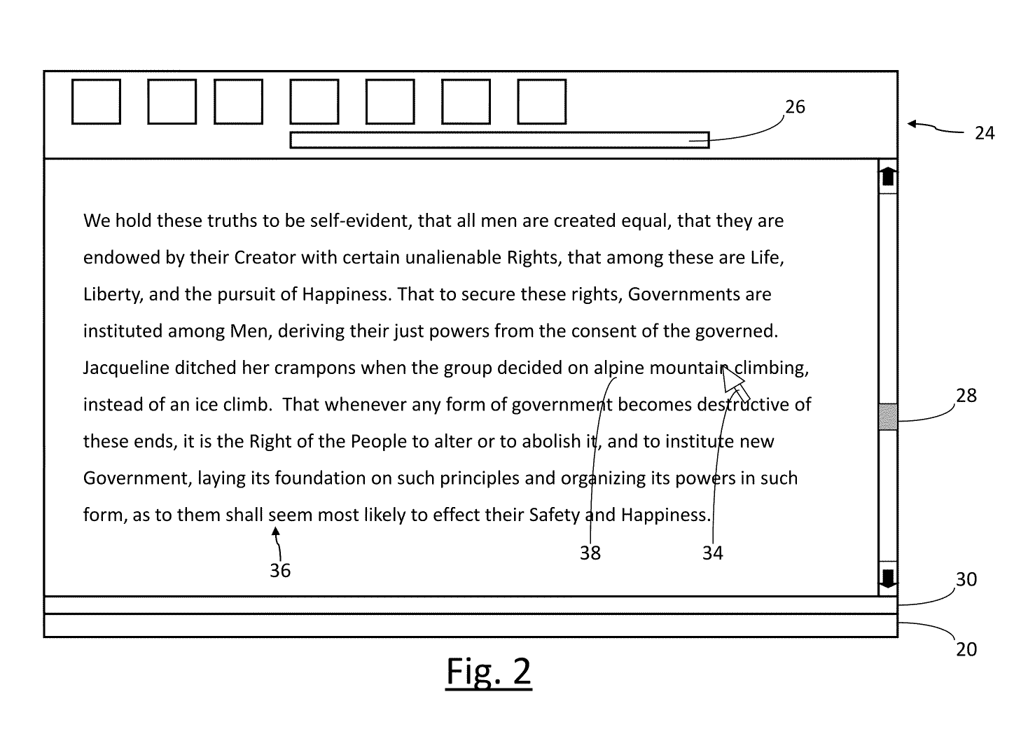

FIG. 2 shows web browser features on a screen with a cursor over the phrase “alpine mountain climbing”.

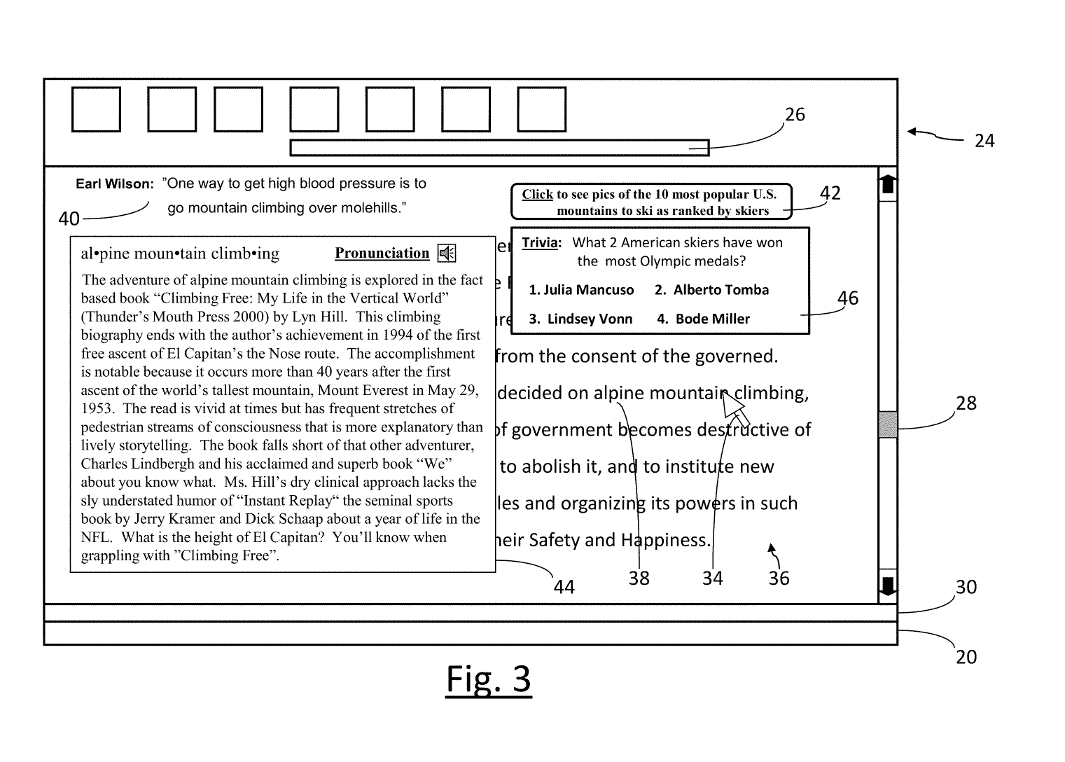

FIG. 3 shows associated information on the screen and the pop-up space educational contents nearby for “alpine mountain climbing” with a complementary related trivia.

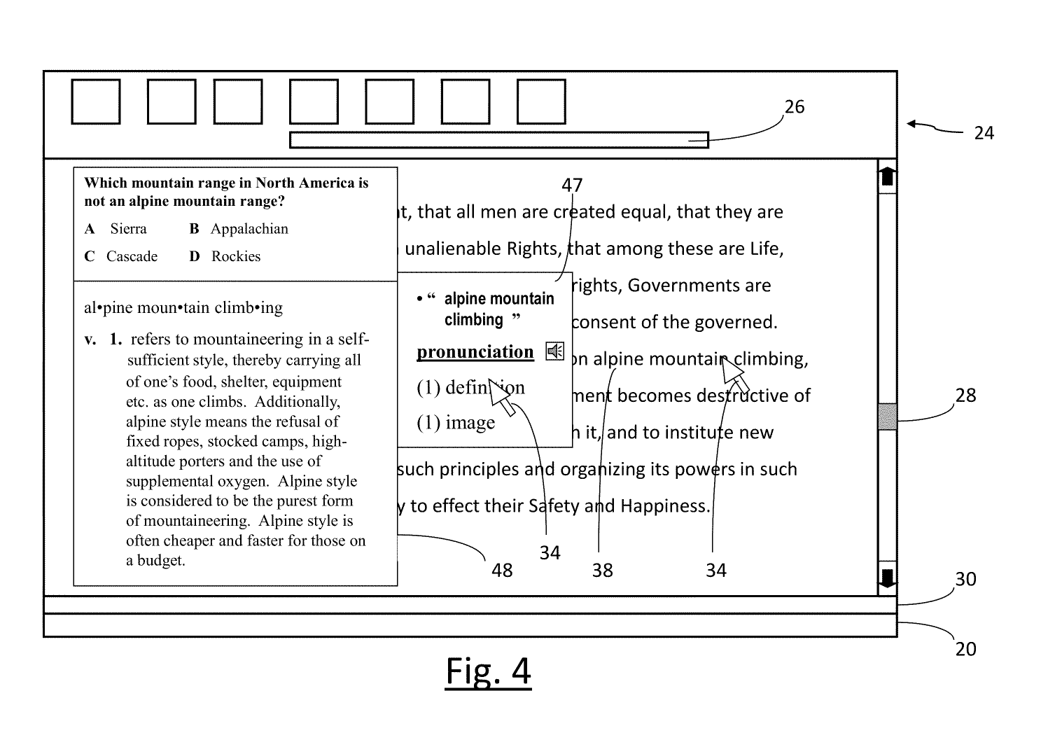

FIG. 4 shows the pop-up space educational contents nearby for “alpine mountain climbing” with another complementary related trivia.

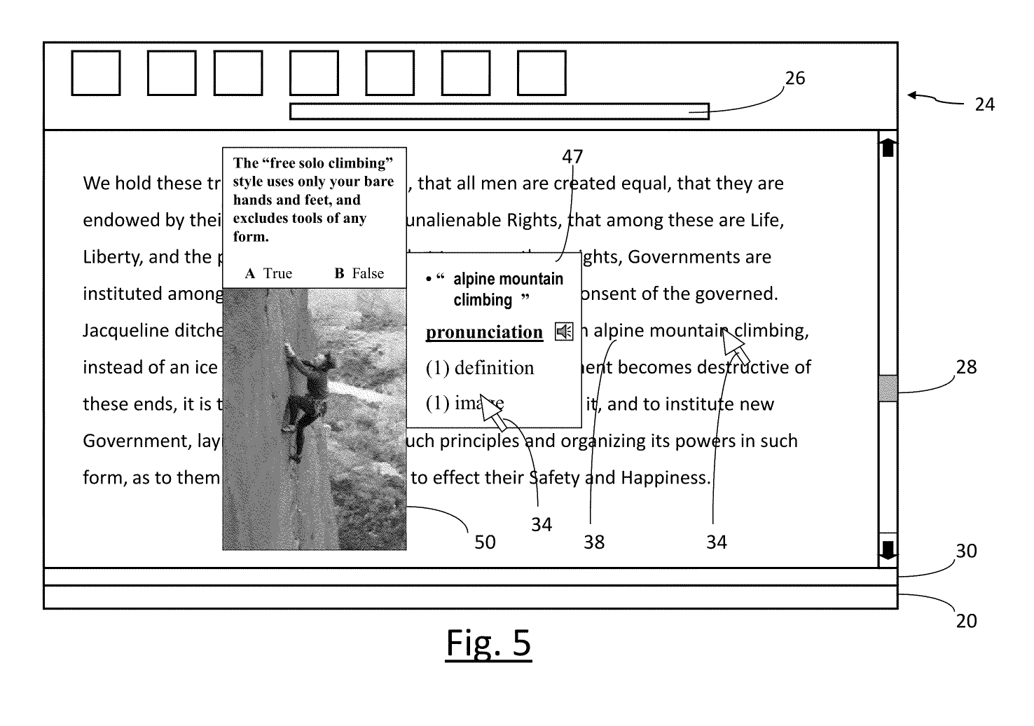

FIG. 5 shows different pop-up space educational contents nearby for “alpine mountain climbing” with another complementary related trivia.

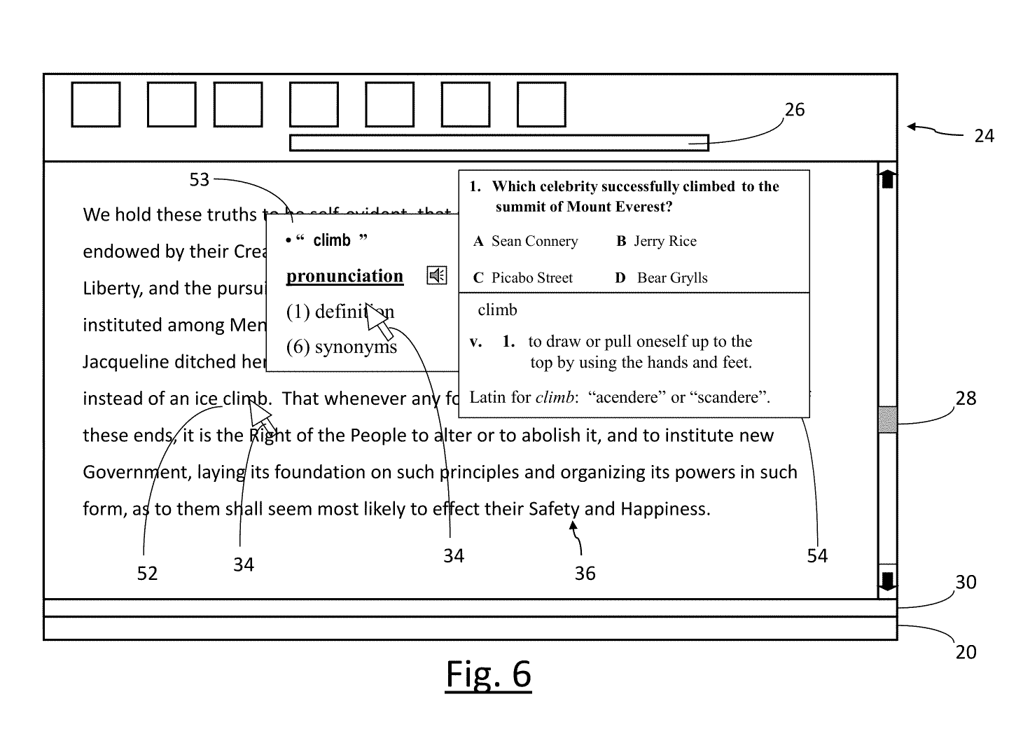

FIG. 6 shows the pop-up space educational contents nearby for the selected “climb” with a complementary related trivia.

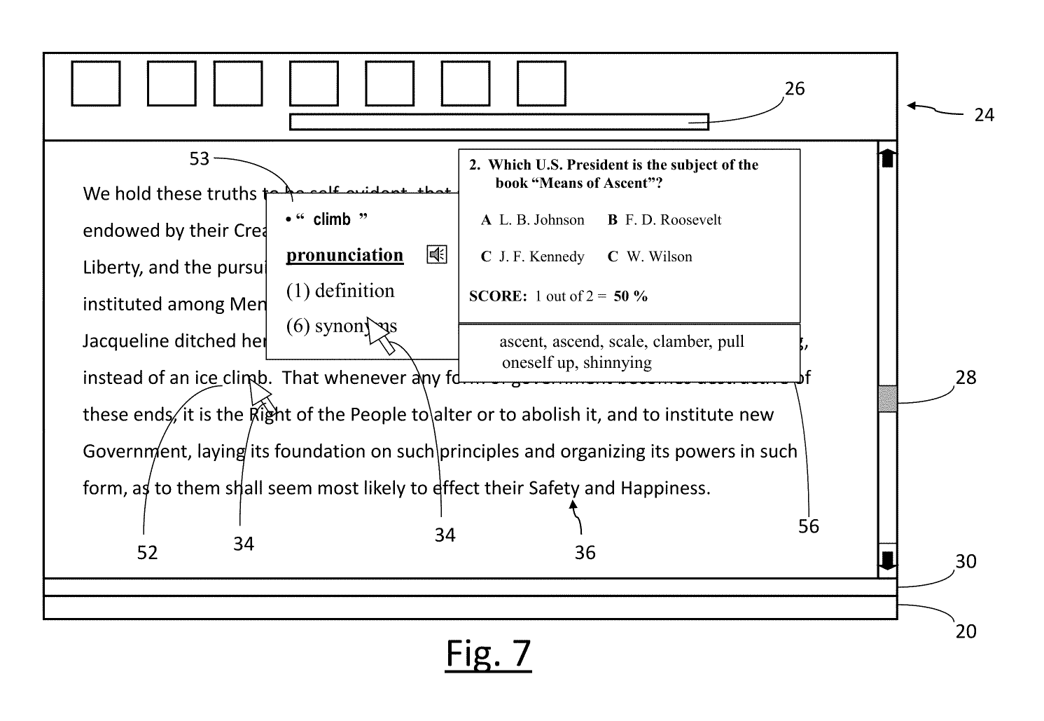

FIG. 7 shows different pop-up space educational contents nearby for “climb” with another complementary related trivia.

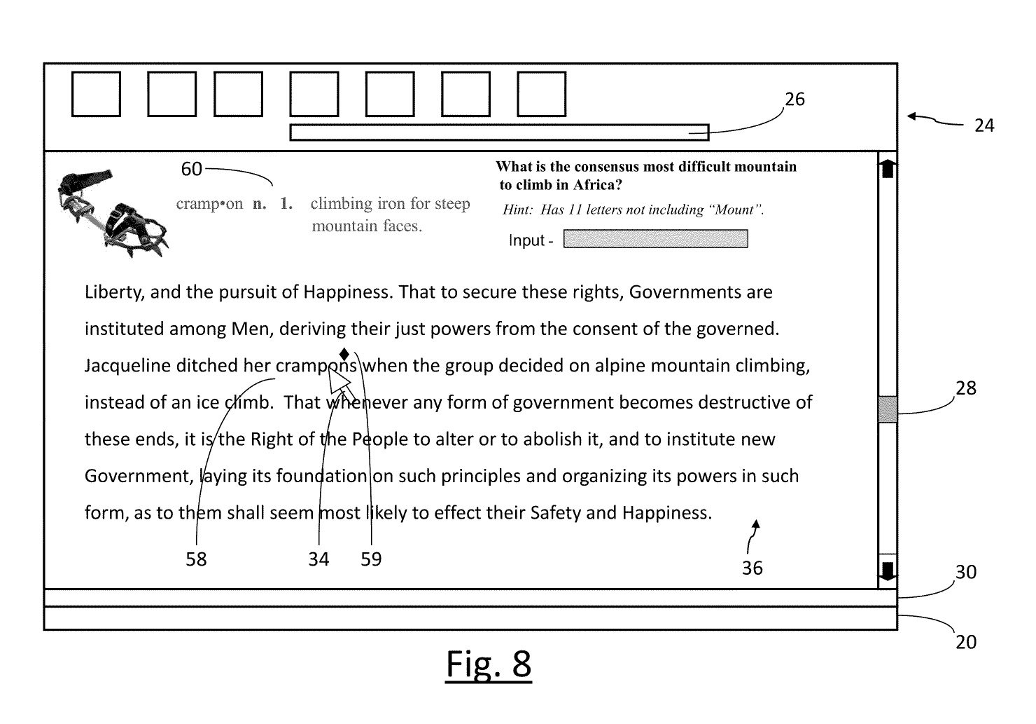

FIG. 8 shows the signaled and selected “crampon”. Both the educational contents and the complementary related trivia are displayed without their pop-up spaces on a blank space at top of the webpage.

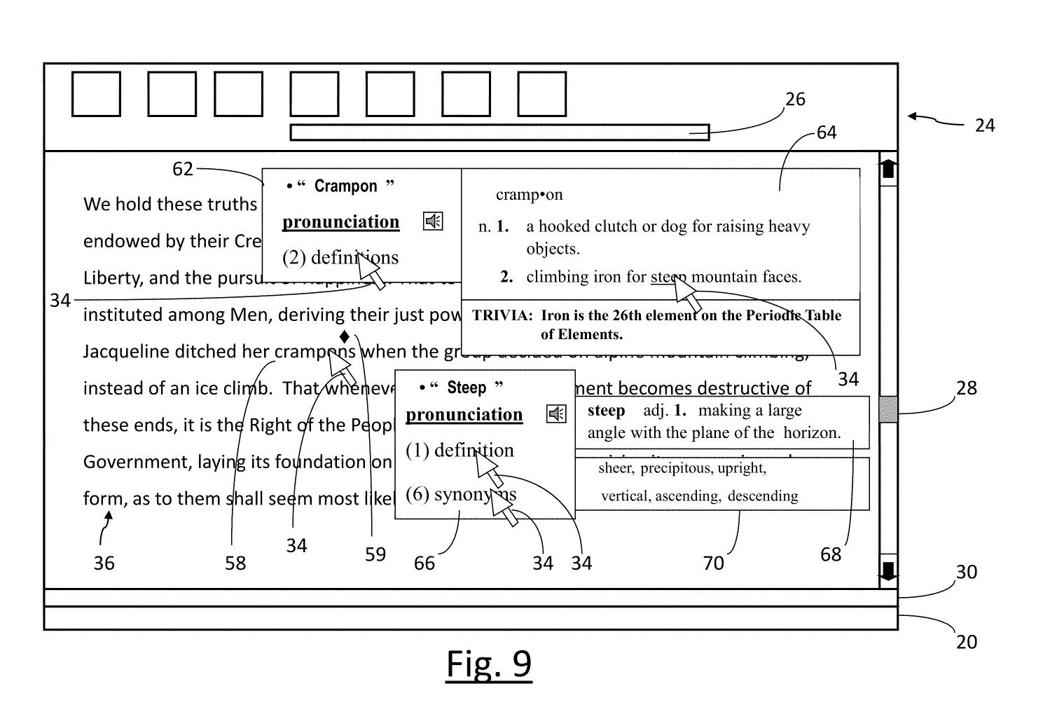

FIG. 9 shows different pop-up space educational contents nearby for “crampon” with another complementary related non-interactive trivia, and two additional different pop-up space educational contents for the selected “steep” from the previous pop-up space educational contents.

### DRAWINGS

### Reference Numerals

| | |
|---|---|
| 10 | computer |
| 12 | screen |
| 14 | central processing unit |
| 16 | keyboard |
| 18 | mouse |
| 20 | operating system information |
| 24 | web browser features |
| 26 | Uniform Resource Locator field |
| 28 | scroll bar |
| 30 | web browser information |
| 34 | cursor |
| 36 | text on the screen |
| 38 | “alpine mountain climbing” phrase |
| 40 | associated information of a quote by Earl Wilson |
| 42 | associated information of a clickable link |
| 44 | pop-up space educational content of a dictionary main entry, syllable |
| | breaks, pronunciation with a selectable speaker icon, literary review, |
| | historical information, and narrative from an extemporaneous work |
| | source for the “alpine mountain climbing” phrase of part 38 |
| 46 | complementary trivia, asking for 2 answers in a multiple |
| | choice format, related to the associated information of part 42 |
| 47 | pop-up space menu with 3 choices with a selectable speaker button |
| 48 | pop-up space educational content of a main entry, syllable breaks, |
| | part of speech, and a definition from an extemporaneous work |
| | source with a complementary trivia, in a multiple choice format, |
| | related to the “alpine mountain climbing” phrase of part 38 |
| 50 | different pop-up space educational content of a moving |
| | image that is a video conveying a meaning for the “alpine mountain |
| | climbing” phrase of part 38 with a complementary trivia, in a true |
| | or false format, related to the video |
| 52 | “climb” word |
| 53 | different pop-up space menu with 3 choices |
| 54 | pop-up space educational content of a main entry, part of speech, a |
| | definition, and a different language of Latin words for the “climb” |
| | word of part 52 with a complementary trivia, the 1^{st} of a series, |
| | related to the main entry and the definition |
| 56 | different pop-up space educational content of 6 synonyms |
| | for the “climb” word of part 52 with a complementary trivia, the |
| | 2^{nd} of a series with a score result, related to 1 synonym |
| 58 | “crampons” word |
| 59 | distinctive signal of “♦” |
| 60 | educational content without a pop-up space of an image that is a |
| | computer generated picture conveying a meaning for the “crampons” |
| | word of part 58, a main entry, syllable break, part of speech, |
| | and a definition, with a complementary trivia (also without a |
| | pop-up space), with a hint and input field, related to the definition |
| 62 | different pop-up space menu with 2 choices |
| 64 | pop-up space educational content of a main entry, syllable break, |
| | part of speech, and 2 definitions, with a complementary |
| | trivia that is non-interactive related to the 2^{nd} definition |
| 66 | different additional pop-up space menu with 3 |
| | choices for the selected “steep” word of part 64 |
| 68 | additional different pop-up space educational content of a main entry, |
| | part of speech, and a definition for the selected “steep” word of part 64 |
| 70 | additional different pop-up space educational |
| | content of 6 synonyms for the selected “steep” word of part 64 |

### DETAILED DESCRIPTION AND OPERATION

### First Embodiment

The title of this application, “Educational Content and/or Dictionary Entry with Complementary Related Trivia”, is hereinafter abbreviated, “Educational with Trivia”. The Educational with Trivia is a computer or internet creation that is a process, a method, and a system. The creation provides educational, learning, informational, and fun results in a fast and convenient process. The purpose of the Educational with Trivia is for enabling an educational, learning, and informational process that displays educational content like a dictionary entry for a word or a phrase. A stimulating, complementary related trivia is also presented. The process is fast, convenient, and fun for a person to use.

First a static physical description of a computer and the internet will be discussed. The computer is an ubiquitous machine that has undergone constant changes in form, speed, and memory size and this will continue as computers evolve presently and in the future. Computers come in all shapes and sizes but share four essential characteristics consisting of the digital input, processing, memory, and output functions.

Computers range in size from small hand-size personal digital assistants (PDA's) to a briefcase-like laptop PC (personal computer) to a typical desktop PC (personal computer). Larger computers like workstations and mainframes do not count for the Educational with Trivia because their size is inappropriate for the intended audience of everyday computer and internet users.

The selection methods of the computer include and are not limited to a keyboard, mouse, touchscreen, touchpad, touch-button, stylus, and voice recognition. Two of the fastest selection methods are placing the cursor over the figurative expression without clicking it, or using the touchscreen method without a stylus.

The largest computer category (the desktop) will be described first and continue downwards in size to the PDA's. The categories mentioned are the prevalent ones and the computer is not limited to those described.

The desktop PC (or microcomputer) looks like a television screen sitting atop a square-looking slab about the size of a small suitcase. The television screen is actually a computer monitor and its screen is the primary output device. The screen shows multimedia text and images. The slab-like box, known as the Central Processing Unit (CPU), houses the processing and memory devices. It is often placed for example somewhere else on the desk or on the floor.

Positioned in front of the monitor or CPU is a flat slab with many buttons called a keyboard. The keyboard is an input device that that is used for typing to enter letters, numbers, characters, other symbols, and for maneuvering on the screen.

The mouse is another input device commonly used with desktop computers and is usually the size of a person's palm. The mouse is placed on a flat surface like a desk so that when a user moves it, the pointer or cursor on the screen moves correspondingly. The mouse often has a few buttons and other features. These features are a means, for example, for the pointer or cursor to draw, insert, point, select, choose, and “click on” a particular spot on the screen.

The last major desktop device, the printer (not shown), is an output device that comes in all shapes, sizes, and types. The average printer is typically a laser printer shaped like a medium-sized moving box. The printer's function, as the name implies, is to print or produce the hard copy (paper) output of the computer. The printer, though not essential to the Educational with Trivia, is included for the sake of thoroughness.

The laptop (not shown), by now a very common machine, combines all of the features and devices of the desktop PC system (with the current exception of a printer) into one single unit. It is typically the size of a large notebook. Laptops are designed to be a portable PC with a very thin monitor and screen that, when closed, is usually positioned face down on the keyboard. A hinge or other similar device typically combines the keyboard and monitor, and the laptop looks like an open clamshell when opened.

Tablets (not shown) and the similar ereaders have the portability of laptops but are smaller with their screens taking up almost all their physical frames. They are typically extremely thin, many are less than an inch thick, and are more or less 9 square inches in size in a rectangular shape. The devices may have a cover or even a clamshell cover but the majority do not. Many tablets and ereaders use the touchscreen as the primary selection method. Tablets use most of the same software and internet applications as the desktop and laptop. Ereaders are for reading electronic books or ebooks, and most tablets also have this capability. Many ereaders use other software and internet applications. Tablets and ereaders often have special software tailored to their unique screen dominated shape and small light size. For example, the screen contents can easily switch 90 degrees to a total of 360 degrees, and easily slide to the next window or ebook page.

Personal digital assistants (PDA's) (not shown) are portable devices designed to be small enough to fit in a human's hand or shirt pocket. Many PDA's are pen-based, meaning that a pen-like stylus is used to do the input functions of the keyboard and mouse by touching the PDA's monitor. PDA's often have organizing functions that allow a person to do scheduling, act like a notepad, store information, calculate, and use many software applications for many other uses.

PDA's, including the tablets and ereaders, can be combined with various other electronic gadgets (not shown) that includes and is not limited to cell phones, pagers, gaming devices, GPS devices, and the like. Cell phones are portable wireless telephones. Pagers are small devices that alert the person to return a call, or receive and send a message. Gaming devices are handhelds that play computer games of all kinds. GPS devices are global positioning systems that provide advanced navigation, location, and mapping features. Any PDA that exhibits multimedia text and images is relevant to the Educational with Trivia.

For PDA's accessing an internet website, the screen typically shows just a portion of the website. The PDA's screen can get the rest of the website by using a scrolling function to go across, or up and down. The PDA's monitor can even display 100% of a website's contents on its small screen. PDA's, including tablets and ereaders, can show a digital keyboard on their screens for inputting functions.

Some desktops, laptops, tablets, ereaders, and PDA's are segments of a broader computer system because they have one or more limited or partial computer components (not shown). The segments can entirely lack the one or more computer components. The components includes and is not limited to hard drives, CPUs, monitors, screens, memories, keyboards, batteries, and internet connectivity.

Some desktops, laptops, tablets, ereaders, and PDA's can have detachable components (not shown) such as a screen. The detached component can be attached to another computer.

All of the computer categories can have peripheral devices (not shown). The peripheral devices includes and is not limited to extra monitors, extra screens, external hard drives, internal hard drives, CD and DVD drives, CDs, DVDs, speakers, portable audio and video recorders, portable PDA and handheld devices, cameras, video projectors, televisions, game devices, flash drives, flash cards, credit and debit card machines, and even cash registers.

Virtually all desktops, laptops, tablets, ereaders, and PDA's can access the internet and an intranet, often by wireless means. The computers are powered using an electrical outlet, sometimes in combination with batteries which are usually rechargeable, or only the batteries.

The internet and the intranet will now be described. The idea of the internet is simple, a vast network of computers of many types that are connected and interact with one another. The whole of the internet could probably be written about in a series of large books.

The following definition of the internet is from the IBM Dictionary of Computing. It defines the internet as, “A wide area network connecting thousands of disparate networks in industry, education, government, and research. The Internet network uses TCP/IP as the standard for transmitting information.”

The TCP/IP is defined by the same dictionary as, “Transmission Control Protocol/Internet Protocol. A set of communication protocols that support peer-to-peer connectivity functions for both local and wide area networks.”

The internet spans many countries, consists of thousands of networks, has millions of users, and will continue to grow and improve. The most relevant feature regarding the internet is the World Wide Web (WWW), with its ability to handle graphics, multimedia, and hypertext links.

The WWW is navigated or surfed with the help of a web browser. A website's address is accessed when its URL (Uniform Resource Locator) or domain name is invoked on the browser's domain name locator. For WWW websites, their address begins with the prefix “www” as in www.websitename.com. The suffix “.com” is a government-created categorization representing the commercial industry. Other examples of these suffixes are “.net”, “.org”, “.edu”, “.mil” and “.gov”. More such suffixes will undoubtedly be created.

The Educational with Trivia is not limited to the WWW, and can be implemented on internet sites without the WWW. It can also utilize and be implemented on internet/television hybrids (not shown).

The Educational with Trivia can be implemented on intranet websites. The following definition of the intranet is from the Dictionary of Computer and Internet Terms. It defines the intranet as, “the opposite of INTERNET, a network confined to a single organization (but not necessarily to a single site). Intranets often include web pages, so a web browser can be used to view the content. This makes the intranet appear just the same as part of the World Wide Web, the only difference is that it is not accessible to those outside the organization. Keeping it separate from the outside world is essential if it carries confidential data, such as internal business records.”

However, it must be re-emphasized that the Educational with Trivia is also applicable to computers and software applications that are independent or offline of the internet and the intranet.

The Educational with Trivia is not limited as to the type of computer on which it runs, and not limited as to the type of network used. This concludes the basic description of the computer hardware, the internet, and the intranet.

Next is a static description of the words displayed on a computer screen. The words includes and are not limited to other words with at least one word such as phrases, sentences, paragraphs, literature, persons, peoples, or subjects. The examples of phrases are “circulatory system”, “technical foul”, “alternative fuels”, “relative atomic mass”, and “environmental impact statement”. For brevity, these words with at least one word are hereinafter “word” or “words”.

The word is displayed within a text or within associated information on a computer screen. The displayed text is a commonplace feature and does not need to be described. For the word's associated information, an example is a medical website displaying varied information. The website shows links, other words, quotations, drop-down menus, images, other text in 5 separate sections and columns, statistics, 3 search fields, and a video that can be played.

The Educational with Trivia operates when a user simply selects a word. This triggers a pop-up space that appears, preferably nearby, presenting educational content about the selected word and one or more complementary related trivia meant to be entertaining. The educational content and the complementary related trivia can be displayed separately although both can be presented in the same pop-up spaces.

The pop-up space itself need not always be a strictly rectangular or window shape. The pop-up space can take many forms, shapes, and sizes. The pop-up spaces includes and are not limited to overlapping spaces, multiple pop-up spaces, 3 dimensional spaces, spaces that look like billowy clouds, and many other spatial images that serve as pop-up spaces.

The pop-up space educational content can include and are not limited to dictionary entries, words, phrases, terms, sentences, text, paragraphs, pages, persons, people, subjects, other reference materials, and visual information such as images and moving images about the selected word.

The dictionary entries can include and are not limited to main entries, definitions, senses, word divisions, parts of speech, pronunciation keys, pronunciation breaks, syllable breaks, variants, synonyms, antonyms, etymologies, usages, idioms, homographs, suffixes, prefixes, inflected forms, example sentences, and quotations. These are merely the prominent examples of the many entries of a dictionary.

More examples of the dictionary entries are binomials, cognate cross-references, directional cross-references, synonymous cross-references, inflectional cross-references, functional labels, stylistic labels, capitalization labels, subject labels, temporal labels, regional labels, lightface types, major stresses, minor stresses, centered periods, run-on entries, small capitals, usage notes, and verbal illustrations.

The other reference materials can include are not limited to almanacs, encyclopedias, compilations, summaries, reviews, criticism reviews, treatises, maps, and directories.

The pop-up space can contain images and imagery that convey a meaning for the selected word, or the other pop-up space educational content (not shown), or the complementary related trivia (not shown). The images includes and are not limited to drawings, illustrations, pictures, photographs, comics, paintings, charts, maps, diagrams, 3 dimensional images, and digital photographs.

The pop-up spaces can contain moving, movement, action, and motion images and imagery that convey a meaning for the selected word, or the other pop-up space educational content (not shown), or the complementary related trivia (not shown). The moving images includes and are not limited to animation, films, movies, videos, cartoons, claymation, stop-action imagery, 3 dimensional action works, digital video works, and computer generated action images.

The pop-up space can contain images or moving images that include and is not limited to renderings of ideas, concepts, processes, thinking, thoughts, spatial motions, immaterial things, metaphysics, stories, plays, plots, tales, enactments, reenactments, jokes, and tall tales.

The pop-up space can display a behind the scenes commentary about its images or moving images (not shown).

The images and moving images can be used to augment the other educational content in the pop-up space. The images and moving images can be presented alone or by themselves without any other educational content in the pop-up space. Ideally, the mode used best helps a person to understand the selected word.

The pop-up space educational content features described above and its forthcoming features that will be described are hereinafter “pop-up content” and “pop-up contents”.

The pop-up content can include and is not limited to literary criticisms, literary reviews, literary summaries, narratives, historical information, symbolic significances, interpretations, reinterpretations, alternative interpretations, revisionist histories, commentaries, motifs, themes, connotations, and to give different perspectives about the selected word.

The computer's sound system can be utilized to produce sounds, such as for the pronunciation of the selected word, text, pop-up content, and complementary related trivia. In addition the sounds can include and are not limited to music, voices, jingles, narrations, voice-overs, and an audio readings and spellings. The sounds can be about the selected word, the text, the associated information, the other pop-up contents, or the complementary related trivia. The sound effects can be produced by selecting, for example, a displayed speaker icon.

The pop-up space can have a menu with at least two choices or options to present the pop-up contents and perhaps the complementary related trivia in an organized manner. Additional selections are necessary to choose the choices on the menus. The drag and selection method, which slides the cursor from one location to another location, can be utilized to make a choice.

The next feature is a complementing or complementary related trivia. The complementary related trivia is a trivial type of information. While the pop-up content information such as a definition is highly important, the complementary related trivia information is inherently unimportant. Since the complementary related trivia is trivial information, it is non-obvious in contrast to the high-valued educational information of the pop-up contents. The complementary related trivia does have educational qualities, however trivial.

The one or more complementary trivia can be related to the associated information on a screen, or related to the selected words, or related to the pop-up contents, or related to any other trivia. The complementary related trivia is hereinafter “trivia” unless described otherwise.

The trivia challenges a person and is engaging and entertaining. The trivia is not only fun but the person may learn something new. The trivia enlivens the dry and boring experience that is often a part of education.

The trivia can be presented in the pop-up content, or it can be presented outside of the pop-up content. The examples of the latter includes and is not limited to displaying the trivia next to the selected word, next to the pop-up content, next to the associated information, next to the text, at the top or bottom of the screen, and in its own pop-up space.

The trivia can be presented in many formats, and includes and is not limited to the following example formats.

One interactive format has a trivia question with multiple choice answers, and when a choice is selected the result is shown. The result is correct or incorrect. Another format has a true or false trivia question, and when one is selected the result is shown. The true or false format can be duplicated to a yes or no format or other like formats. Another format has a trivia question, and when an answer is entered into an input field the result is shown.

Another format has a trivia question with a hint feature that displays the hint information, or display variations of a “hint” link that can be selected to show the hint information. Another format has a series of trivia questions and answers, then showing a score result. Another format has a statement, sentence, partial statement or partial sentence instead of a question.

Another format asks for more than one answer and displays the more than one correct answers and at least one incorrect answer in a multiple choice format. Another format asks for more than one answer and the answers are entered into an input field, or typed on the screen. Another format displays interesting, amusing trivia information that is non-interactive, or without the response, answer, or input features.

The next feature is the sources (not shown) that can be utilized for the pop-up contents and the trivia. The sources include and are not limited to reference works, databases, all communications mediums, and extemporaneous works.

The reference works source includes and is not limited to dictionaries, almanacs, encyclopedias, subject oriented encyclopedias, compilations, subject oriented dictionaries, subject oriented summaries, subject oriented records, annual records, reviews, criticisms, treatises, maps, atlases, directories, and thesis publications. Any other reference works that are a source for the selected words' pop-up contents and the trivia can be utilized.

The database source includes and is not limited to servers, internet databases, network databases, computer storage devices, computer-readable devices, hard drives, and the memory from the computers of individuals, businesses, and organizations.

The communications medium source includes and is not limited to paper, published material, art works, photography, radio, telephone, television, movies, electronic hardware, computer, internet, portable playable and recording devices. The portable playable devices includes and are not limited to phonograms, photographs, vinyl records, tape cassettes, cassettes, videocassettes, CDs, DVDs, computer disks, computer chips, computer plug-ins, pc cards, flash cards, and even zoetropes.

The extemporaneous works sources are productions or works from the ad hoc creativity of people. The extemporaneous works sources includes and are not limited to writers, editors, artisans, illustrators, artists, painters, photographers, filmmakers, directors, producers, cameramen, actors, singers, deejays, dancers, and musicians.

For the trivia, in addition to the above mentioned sources, its sources includes and are not limited to all information ranging from books to electronic literature to individuals to new emerging research or knowledge.

The different sources can be mixed together in a combination.

The next feature is the pop-up contents and the trivia can be shown in large sized font, large sized text, and in enlarged images or moving images (not shown) that are helpful for the visually impaired. For easier viewing, the colors and contrast of the pop-up contents and the trivia can be enhanced and adjusted.

The next feature is a caption or a subtitle (not shown) that can be displayed which parallel the sound effects of the pop-up contents and the trivia that are helpful for the hearing impaired. The captions or subtitles can play whether the sound is on or off. The captions or subtitles can be shown outside of the pop-up content. The examples of this includes and is not limited to displaying them at the bottom of the screen, next to the selected words, next to the associated information, next to the pop-up content, and next to the trivia.

The pop-up content and the trivia cooperate to make learning about words more educating and exciting. The pop-up content and entertaining trivia adds value and increases the popularity of a digital application, digital property, and digital product or service.

It is emphasized, with the exception of the trivia, that all of the above features of the pop-up content are not required to be used at the same time. The features include those described in the next sections on additional and alternative embodiments. The features are options that can be used to best assist a person to understand, learn, and be informed about the selected words. The options used can depend on the makeup, age, language, and occupation of an audience. The wishes of writers, directors, artists, editors, producers, executives, and other people can be factors.

### Description of Additional Embodiments

An additional embodiment is that every word on the computer screen does not implement the pop-up content and the trivia. For the words with the latent pop-up content and the trivia, its existence can be indicated with a special or distinctive signaling feature. For example, the symbol “♦” is placed on or next to the word. To further distinguish the signal, it can be colored red, for instance. The embodiment reduces overexposure by having only relatively difficult or hard-to-understand words, and perhaps with respect to the intended audience. This embodiment reduces digital file sizes, saves memory space, and speeds up internet download and upload times.

Another additional embodiment is that the pop-up contents and trivia can be calibrated to a level of difficulty and sophistication with respect to an age of an intended audience (not shown). Some broad categories loosely define the age groups. The categories includes and are not limited to pre-school, elementary school, junior high school, high school, young adults, adults, twenty-something, thirty-something, and seniors audiences.

Another additional embodiment is that the pop-up contents and trivia can be customized with respect to an intended occupational audience (not shown). There are innumerable occupations that includes and are not limited to physicians, HVAC professionals, computer programmers, carpenters, airplane pilots, and organic biologists.

Another embodiment involves pop-up spaces within pop-up spaces. Any of the pop-up contents and trivia themselves can be selected to trigger their own latent pop-up content and perhaps a trivia (not shown). These pop-up contents and trivia can have their own distinctive signals to denote that the latent pop-up content or trivia is available. The later or subsequent trivia can be unrelated to anything on the screen or it can be related to the associated information on the screen, or related to the selected words, or related to the selected pop-up contents, or related to the selected trivia, or any other trivia. Theoretically this can be repeated indefinitely. However information overload and screen space constraints will likely limit this practice to a few times.

Another additional embodiment is that the text or associated information displayed on the screen are in a different language or dialect than the language or dialect of the pop-up contents and trivia.

Another additional embodiment is that the pop-up contents and trivia can use at least two different languages from among all the languages of the world, past and present. The language embodiments benefits a person interested in learning about a different language.

Thus the current application helps a person learn about words. At the same time the person is entertained and challenged by the fun and exciting trivia. The process uses the fast selecting step and the convenient pop-up space. The pop-up space presents one or more of a plethora of the very useful educational content features. The assembled process is basic and compact.

### Description of Alternative Embodiments

An alternative embodiment is that the educational contents for the selected words can be displayed without the pop-up space or by not implementing the pop-up space. The examples include and are not limited to the following examples. An example is displaying the educational contents in the right, left, top, or bottom margins of the page or the screen, or displaying them in open, blank, empty, clear, or unused spaces on a website or webpage.

Another example is displaying the educational contents near the selected word, and the educational contents are in fonts, font styles, font sizes, font effects, or font colors that contrast with the displayed text or the displayed associated information on the screen. Other examples are highlighting the educational contents, or encircling them with a border with or without the highlighting.

The trivia are displayed in the different ways previously described including outside of or, like in this embodiment, without the pop-up space.

Another alternative embodiment is when the educational contents without the pop-up spaces are selected, to display a pop-up space with their own educational content and perhaps a trivia (not shown). These educational contents can have their own distinctive signals to denote that their latent pop-up content and optional trivia is available. The later or subsequent trivia can be related or unrelated.

Thus the alternative embodiment displays one or more of a plethora of the very useful educational content features previously described but without the pop-up space. The alternative embodiment still helps the person learn about words, while at the same time being entertained and challenged by the fun and exciting trivia. The assembled process is basic yet elegant.

The advantages of the additional and alternative embodiments are numerous.

### ADVANTAGES

A number of advantages of some embodiments of the Educational with Trivia are:
(a) for words on a screen, to display educational content for them, and fun complementary related trivia in a simple, fast, and convenient process;
(b) when a word is selected, educational content for the word and the trivia instantly appears;
(c) a pop-up space can be utilized to present the educational content;
(d) the educational content can be can be dictionary entries or other reference materials;
(e) the educational content can be, for example, dictionary entries such as definitions, senses, syllable breaks, pronunciations, functional labels, parts of speech, synonyms, antonyms, etymologies, variants, usages, idioms, or quotations;
(f) the educational content can be, for example, images such as pictures, photographs, illustrations, paintings, drawings, comics, charts, maps, or diagrams that convey a meaning for the word, or the other educational contents, or the trivia;
(g) the educational content can be, for example, moving images such as films, videos, digital video works, animation, claymation, stop-action, or cartoons that convey a meaning for the word, or the other educational contents, or the trivia;
(h) a sound system can be utilized, such as for the pronunciation of the words, their pop-up contents, or trivia. The examples of other sound effects are narrations, voice-overs, and music;
(i) the captioning or subtitles of the sound effects, whether the sound system is on or off, can be displayed that are helpful for the hearing impaired;
(j) the educational content and trivia can be shown, for example, in large sized font, large sized text, enlarged images, enlarged moving images, or its colors and contrast can be enhanced or adjusted that are helpful for the visually impaired;
(k) the trivia is related to the associated information on the screen, or the selected words, or the educational contents, or any other trivia;
(l) the challenging trivia can be presented in varied formats, for example, a series of questions and multiple choice answers with a final score;
(m) the trivia, preferably amusing, can be presented in non-interactive formats;
(n) the educational content and entertaining trivia adds value and increases the popularity of a digital product or service;
(o) to calibrate the level of difficulty of the educational content and trivia with respect to the age of the intended audience;
(p) to customize the educational content and trivia with respect to the occupation of the intended audience;
(q) the sources of the educational contents or the trivia can be from reference works, databases, any communications mediums, and extemporaneous works;
(r) the language of the text, the associated information, and the word displayed on the screen is different from the language of the educational content and trivia;
(s) the educational content and trivia uses at least two different languages; and
(t) the many features of the educational content, except for the trivia, are options that can be presented to best assist a person to learn about the word.

These and other advantages of one or more embodiments are apparent from a consideration of the above description and accompanying drawings.

### CONCLUSION, RAMIFICATIONS, AND SCOPE

Accordingly the current application provides a fast convenient way of acquiring what a word or phrase means. The complementary related trivia is also displayed.

A user simply selects the word to instantly get the educational contents like a dictionary definition or a video to understand it. The always popular and fun trivia makes the learning experience more enjoyable.

Although the above description contains many specificities, these should not be construed as limiting the scope of the embodiments, but as merely providing exemplifications of some of the embodiments. Many other variations are possible.

For example instead of limiting the educational contents and the trivia to the above described features, more different features can be implemented such as blogs, surveys, rating systems, save function, email function, texting function, chat services, and other social media services.

Thus the scope of the embodiments should be determined by the appended claims and their legal equivalents, rather than by the examples given.

I claim:

1. A process, comprising:
a. providing a computer,
b. providing a screen of said computer,
c. utilizing a word displayed on said screen,
d. implementing an educational content substantially about said word on said screen,
e. implementing a complementary related trivia, and
f. enabling a user to substantially select said word on said screen which triggers said educational content substantially about said word and displaying said complementary trivia.

2. The process of claim 1 further including enabling at least 1 pop-up space to present said educational content.

3. The process of claim 1 wherein said complementary related trivia is interactive or non-interactive, and said interactive or non-interactive complementary trivia is substantially related to said word, said educational content, an associated information displayed on said screen, or another trivia.

4. The process of claim 1 wherein said educational content is a definition for said word.

5. The process of claim 1 wherein said educational content is a dictionary sense, a part of speech, an etymology, or a pronunciation sound effect for said word.

6. The process of claim 1 wherein said educational content is a dictionary entry for said word.

7. The process of claim 1 wherein said educational content is a reference material for said word.

8. The process of claim 1 wherein said educational content is a literary review, a historical information, or a narrative for said word.

9. The process of claim 1 wherein said educational content picture, video, or a computer generated imagery substantially conveying a meaning said word.

10. The process of claim 1 wherein said educational content is a photograph, an image, or a moving image substantially conveying a meaning for said word.

11. The process of claim 1 wherein said educational content or said complementary related trivia is from an extemporaneous work source.

12. A system, comprising:
a computer;
a screen of said computer;
a word or phrase displayed on said screen;
an educational content substantially about said word or phrase on said screen;
a complementary related trivia; and
a user substantially selects said word or phrase on said screen which triggers said educational content substantially about said word or phrase and displaying said complementary trivia.

13. The system of claim 12 further including: enabling at least 1 pop-up space to present said educational content.

14. The system of claim 12 wherein: said complementary related trivia is interactive or non-interactive, and said interactive or non-interactive complementary trivia is substantially related to said word or phrase, said educational content, an associated information displayed on said screen, or another trivia.

15. The system of claim 12 wherein: said educational content is a definition, a sense, a part of speech, or an etymology for said word or phrase.

16. The system of claim 12 wherein: said educational content is a dictionary entry, a reference material, or a pronunciation sound effect for said word or phrase.

17. The system of claim 12 wherein: said educational content is a literary review, a historical information, or a narrative for said word or phrase.

18. The system of claim 12 wherein: said educational content is a picture, video, or a computer generated imagery substantially conveying a meaning said word.

19. The system of claim 12 wherein: said educational content is a photograph, an image, or a moving image substantially conveying a meaning for said word.

20. The system of claim 12 wherein: said educational content or said complementary related trivia is from an extemporaneous work source.
